(19) United States
(12) Patent Application Publication
(10) Pub. No.: US 2006/0228281 A1
(43) Pub. Date: Oct. 12, 2006

(54) Method and plant for removing gaseous pollutants from exhaust gases

(76) Inventors: Michael Ströder, Neu-Anspach (DE); Stuart Sneyd, Frankfurt am Main (DE); Klaus Hasselwander, Oberursel (DE)

Correspondence Address: MORGAN & FINNEGAN, L.L.P., 3 WORLD FINANCIAL CENTER, NEW YORK, NY, 10281-2101, US

(21) Appl. No.: 10/540,437

(22) PCT Filed: Nov. 14, 2003
(86) PCT No.: PCT/EP03/12726

§ 371 Date: May 10, 2006

(30) Foreign Application Priority Data
Dec. 23, 2002 (DE) 102 60 740.0

(51) Int. Cl. B01D 53/34

(52) U.S. Cl. 423/212

(57) ABSTRACT

The present invention relates to a method for removing gaseous pollutants from exhaust gases, in which the gaseous pollutants react with a fine-grained reactant by forming solids in a fluidized-bed reactor (2), and to a corresponding plant. To achieve low pollutant concentrations in the clean gas with an almost stoichiometric consumption of reactant, it is proposed to introduce the exhaust gas from below through a preferably central gas supply tube (20) into a mixing chamber (21) of the reactor (2), the gas supply tube (20) being at least partly surrounded by a stationary annular fluidized bed (22) of reactant, which bed is fluidized by supplying fluidizing gas, and to adjust the the gas velocities of the exhaust gas and of the fluidizing gas for the annular fluidized bed (22) such that the Particle-Froude-Numbers in the gas supply tube (20) are between 1 and 100, in the annular fluidized bed (22) between 0.02 and 2, and in the mixing chamber (21) between 0.3 and 30.

### TECHNICAL FIELD

The present invention relates to a method for removing gaseous pollutants from exhaust gases, in which the gaseous pollutants react with a fine-grained reactant by forming solids in a fluidized-bed reactor, and to a corresponding plant.

Such methods and plants are used for instance for removing acid gases such as SO₂, HF and HCl from the flue gas stream of combustion plants, such as power plants, incineration plants for waste and special waste, or of another thermal production process, for instance the production of aluminum in electrolytic cells. For this purpose, a multitude of different wet, dry and quasi-dry processes was developed, in which the removal of the acid components is effected by adding alkaline reagents. In the case of dry processes, entrained-bed and fluidized-bed methods are used, and in particular methods with a circulating Venturi-type fluidized bed.

As compared to stationary fluidized beds, circulating fluidized beds have better mass and heat transfer conditions due to the higher degree of fluidization and allow the integration of a suspension heat exchanger, but are restricted as regards their solids retention time. In particular in the case of fluctuating exhaust gas quantities, this leads to a problematic control behavior. What is also disadvantageous is a high pressure loss and in some cases a poor utilization of the reactant.

### DESCRIPTION OF THE INVENTION

Therefore, it is the object of the present invention to improve the mass and heat transfer conditions and the conversion of the reactant in the dry exhaust gas cleaning.

In accordance with the invention, this object is solved by a method as mentioned above, in which the exhaust gas is introduced from below through a preferably centrally arranged gas supply tube (central tube) into a mixing chamber of the reactor, the central tube being at least partly surrounded by a stationary annular fluidized bed of reactant, which bed is fluidized by supplying fluidizing gas, and in which the gas velocities of the exhaust gas as well as of the fluidizing gas for the annular fluidized bed are adjusted such that the Particle-Froude-Numbers in the central tube are between 1 and 100, in the annular fluidized bed between 0.02 and 2, and in the mixing chamber between 0.3 and 30.

In the case of the exhaust gas cleaning by means of the method of the invention, the advantages of a stationary fluidized bed, such as a sufficiently long reactant retention time, and the advantages of a circulating fluidized bed, such as a good mass and heat transfer, can surprisingly be combined with each other, while the disadvantages of both systems are avoided. When passing through the upper region of the central tube, the exhaust gas entrains reactant from the annular stationary fluidized bed, which is referred to as annular fluidized bed, into the mixing chamber, so that due to the high slip velocities between the reactant and the exhaust gas an intensively mixed suspension is formed and optimum reaction conditions between the two phases are achieved. By correspondingly adjusting the bed height in the annular fluidized bed as well as the gas velocities of the exhaust gas and the fluidizing gas, the reactant loading (solids loading) of the suspension above the orifice region of the central tube can be varied within wide ranges, so that the pressure loss of the first gas between the orifice region of the central tube and the upper outlet of the mixing chamber can be between 1 mbar and 100 mbar. In the case of a high solids loading of the suspension in the mixing chamber, a large part of the reactants and/or the solids formed during the reaction will separate out of the suspension and fall back into the annular fluidized bed. This recirculation is called internal solids recirculation, the solids/reactant mass flow circulating in this internal circulation normally being significantly larger than the amount of reactant supplied to the reactor from outside. The (smaller) amount of not precipitated solids or reactant is discharged from the mixing chamber together with the exhaust gas. The retention time of the solids and of the reactant in the reactor can be varied within wide limits by the selection of height and (cross-sectional) area of the annular fluidized bed and be adjusted to the desired reaction. Due to the high solids loading on the one hand and the good reaction conditions on the other hand, excellent conditions for an almost stoichiometric consumption of the reactant are obtained above the orifice region of the central tube. The amount of solids and reactant entrained from the reactor with the gas stream is completely or at least partly recirculated to the reactor, with the recirculation expediently being fed into the stationary fluidized bed. Apart from the excellent utilization of energy, another advantage of the method in accordance with the invention consists in achieving very low pollutant concentrations in the clean gas with almost stoichiometric consumptions of the reactant, where the method can be adjusted to the requirements quickly, easily and reliably.

To ensure a particularly effective mass transfer in the mixing chamber and a sufficient retention time in the reactor, the gas velocities of the exhaust gas and of the fluidizing gas are preferably adjusted for the fluidized bed such that the dimensionless Particle-Froude-Numbers (Fr_{P}) are 20 to 90 in the central tube, 0.2 to 2 in the annular fluidized bed and/or 3 to 15 in the mixing chamber. The Particle-Froude-Numbers are each defined by the following equation:

$${Fr}_{P} = \frac{u}{\sqrt{\frac{( {ρ}_{s} - {ρ}_{f} )}{{ρ}_{f}} * {d}_{p} * g}}$$

with
u=effective velocity of the exhaust gas flow in m/s
pₛ=density of the solid particle (reactant) in kg/m³
p_{f}=effective density of the fluidizing gas in kg/m³
dₚ=mean diameter in m of the particles of the reactor inventory (or the particles formed) during operation of the reactor
g=gravitational constant in m/s².

When using this equation it should be considered that dₚ does not indicate the mean diameter (d₅₀) of the material used, but the mean diameter of the reactor inventory formed during operation of the reactor, which can differ significantly in both directions from the mean diameter of the material used (primary particles). Even from very fine-grained material with a mean diameter of e.g. 3 to 10 μm, particles (secondary particles) with a mean diameter of 20 to 30 μm can for instance be formed during the heat treatment. On the other hand, some primary particles are decrepitated during the heat treatment in the reactor.

In accordance with a development of the invention it is proposed to adjust the bed height of reactant in the reactor such that the annular fluidized bed extends beyond the upper orifice end of the central tube for instance by a few centimeters, and thus reactant is constantly introduced into the exhaust gas and entrained by the gas stream to the mixing chamber located above the orifice region of the central tube. In this way, there is achieved a particularly high solids/reactant loading of the suspension above the orifice region of the central tube.

The method in accordance with the invention can in particular be used for cleaning exhaust gas containing sulfur dioxide, hydrogen fluoride and/or hydrogen chloride, and as reactant there is supplied in particular alumina, sodium carbonate and/or calcium compounds, for instance hydrated or burnt lime. The grain size at least of the major part of the reactant supplied preferably is smaller than 100 μm.

In accordance with a further aspect of the proposed method, the exhaust gas can be dedusted before being supplied to the reactor, in order to obtain clearly defined reaction conditions.

In accordance with the method of the invention, solids and possibly reactant formed during the reaction of the exhaust gas with the circulating reactant are partly discharged from the reactor together with the exhaust gas stream and supplied to at least one separator, after the reaction in the reactor. The solids separated in said separator as well as the reactant are either wholly or partly recirculated into the annular fluidized bed and/or mixing chamber of the reactor or discharged for a certain part. Inside the separator, which in particular includes a coarse separator such as a cyclone or shutter-type separator and a downstream fine separator such as an electrostatic or bag filter, the solids (reaction product) discharged with the gas stream flowing through the central tube and the entrained reactant are separated and at least partly recirculated into the annular fluidized bed of the reactor via a solids return conduit. An essential advantage of this flexible solids recirculation consists in that the solids/reactant loading of the suspension in the vicinity of the mixing chamber of the reactor can specifically be adjusted to the requirements of the process and even be changed during operation as required. In accordance with the invention, the recirculated amount of solids can be up to 10 times the freshly added amount of reactant.

For adjusting the recirculation amount it is quite useful,in accordance with the invention to measure the pressure loss above the mixing chamber between the central tube and the discharge conduit of the reactor, which leads to the separator, and to control the recirculation amount in dependence on this differential pressure by varying the recirculated amount of solids/reactant. For this purpose, the pressure loss is measured by means of a measuring device and provided to a controller, which adjusts the pressure loss to a predeterminable desired value by changing the recirculation amount supplied. What turned out to be particularly advantageous for this purpose is a fluidized intermediate container with downstream dosing member, for instance a variable-speed star feeder or a roller-type rotary valve, where the amount of solids or reactant not required for recirculation can be discharged for instance by means of an overflow and be supplied to another process for further usage. The recirculation in a simple way contributes to keep constant the process conditions inside the reactor and/or prolong the mean retention time of the solids/reactant inside the reactor.

In accordance with the invention, the supply of reactant is effected in dependence on the concentration of the pollutants in the cleaned exhaust gas. The concentration is measured by means of a measuring device for instance in an exhaust gas conduit leading to the discharge chimney, and the measured value obtained is supplied to a controller which then automatically controls the supply of reactant such that the desired concentration of the pollutants in the cleaned exhaust gas is achieved.

As gas for fluidizing the annular fluidized bed, air is preferably supplied to the reactor, and to this end all other gases or gas mixtures known to the expert for this purpose can of course be used. It may also be advantageous to use or admix cleaned exhaust gas as fluidizing gas. The introduction of gas into the annular fluidized bed and the gas velocity can be increased thereby, which leads to a rise in the reactant level and hence an increased introduction of reactant into the mixing chamber, as more reactant is entrained by the exhaust gas flowing through the central tube. By means of this increased specific amount of reactant, e.g. pollutant peaks can be eliminated or improved clean gas values can be achieved. In accordance with the invention, the rate of the recirculated cleaned exhaust gas can depend on the pollutant concentration in the cleaned exhaust gas, and normally can in particular lie between 5 and 10% of the amount of exhaust gas supplied to the reactor.

For adjusting an optimum process temperature it is furthermore proposed to perform an injection of water into the reactor in dependence on the temperature in the reactor and/or the temperature of the cleaned exhaust gas leaving the reactor. As a result, an adiabatic evaporation takes place, by means of which the temperature in the reactor can be adjusted in a simple way. The injection of water can be effected both into and onto the annular fluidized bed.

To compensate fluctuations in the raw gas volume of the exhaust gas to be cleaned, which is supplied to the reactor, cleaned exhaust gas is admixed to the exhaust gas in the central tube as clean gas, in particular in dependence on the exhaust gas volume flow. In this way, stable reaction conditions can be created in the annular-fluidized-bed reactor.

A plant in accordance with the invention, which is in particular suited for performing the method described above, has a reactor constituting a fluidized-bed reactor for receiving reactant which reacts with the gaseous pollutants from the exhaust gases, the reactor having a gas supply system which is formed such that exhaust gas flowing through the gas supply system entrains solids from a stationary annular fluidized bed, which at least partly surrounds the gas supply system, into the mixing chamber. Preferably, this gas supply system, which can in particular have a gas supply tube, extends into the mixing chamber. It is, however, also possible to let the gas supply system end below the surface of the annular fluidized bed and close it at the top. The gas is then introduced into the annular fluidized bed e.g. via lateral apertures, entraining solids from the annular fluidized bed into the mixing chamber due to its flow velocity.

For this purpose, the gas supply system has a gas supply tube (central tube) extending upwards substantially vertically from the lower region of the reactor, which is surrounded by a chamber which at least partly annularly extends around the central tube and in which the stationary annular fluidized bed is formed. The central tube can constitute a nozzle at its outlet opening and have one or more apertures distributed around its shell surface, so that during the operation of the reactor reactant constantly gets into the central tube through the apertures and is entrained by the exhaust gas through the central tube into the mixing chamber. Of course, two or more central tubes with different or identical dimensions and shapes may also be provided in the reactor. Preferably, however, at least one of the central tubes is arranged approximately centrally with reference to the cross-sectional area of the reactor.

In accordance with a preferred embodiment, at least one separator for separating solids which also include entrained reactant is provided downstream of the reactor, which separator can include a coarse separator, in particular a cyclone and/or a shutter-type mechanical separator, and downstream thereof a fine separator, in particular an electrostatic or bag filter. In accordance with the invention, a recirculation system comprising a solids conduit leading to the annular fluidized bed of the reactor, a solids conduit leading to the mixing chamber of the reactor and/or a solids discharge conduit is provided downstream of the separator. The recirculation provides for a particularly good utilization of the reactant, which can easily be adjusted to the respective reaction conditions. For this purpose, the recirculation system preferably includes a buffer vessel for the temporary storage of solids and reactant as well as a dosing means for the controlled recirculation to the reactor.

To provide for a reliable fluidization of the solids and the formation of a stationary fluidized bed, a gas distributor is provided in the annular chamber of the reactor, which divides the chamber into an upper annular fluidized bed and a lower gas distributor, the gas distributor being connected with a supply conduit for fluidizing gas, in particular air and/or cleaned exhaust gas. The gas distributor (tuyere bottom) can constitute for instance a gas distributor chamber covered with a fabric or a gas distributor composed of tubes and/or nozzles.

Behind the separator, on the exhaust gas side, a clean gas supply conduit is provided in accordance with the invention for recirculating clean gas into the annular fluidized bed of the reactor and/or into the central tube, so that the exhaust gas to be cleaned can be mixed with already cleaned exhaust gas, in order to be able to compensate and control fluctuations in the volume flow of the exhaust gas to be cleaned, for which purpose the raw exhaust gas volume flow can be detected by suitable measuring devices in accordance with the invention.

For adjusting an optimum reaction temperature, a water supply conduit is provided in accordance with the invention for injecting water into and/or onto the annular fluidized bed of the reactor.

The plant in accordance with the present invention furthermore has a differential pressure gauge in particular for measuring the pressure loss in the reactor, a temperature gauge in particular for measuring the temperature in the reactor or in the exhaust gas stream leaving the reactor, and/or a gas meter in particular for measuring the clean gas concentration in the cleaned exhaust gas. In accordance with the invention, these measured values are supplied to corresponding controllers, in order to control in particular the reactant supply, the recirculation, the admixture of cleaned exhaust gas to the exhaust gas stream to be cleaned, the injection of water into the annular fluidized bed of the reactor or other reaction parameters. In accordance with the invention, such control of pressure, temperature and/or concentration of the pollutants in the clean gas is effected by means of the aforementioned measuring devices, which are connected to the controller for instance via a cable or radio connection.

In the annular fluidized bed and/or the mixing chamber of the reactor, means for deflecting the solid and/or reactant flows may be provided in accordance with the invention. It is for instance possible to position an annular weir, whose diameter lies between that of the central tube and that of the reactor wall, in the annular fluidized bed such that the upper edge of the weir protrudes beyond the solids level obtained during operation, whereas the lower edge of the weir is arranged at a distance from the gas distributor or the like. Thus, solids separated out of the mixing chamber in the vicinity of the reactor wall must first pass by the weir at the lower edge thereof, before they can be entrained by the gas flow of the central tube back into the mixing chamber. In this way, an exchange of solids or reactant is enforced in the annular fluidized bed, so that a more uniform retention time of the solids and the reactant in the annular fluidized bed is obtained.

Developments, advantages and possible applications of the invention can also be taken from the following description of embodiments and the drawing. All features described and/or illustrated in the drawing form the subject-matter of the invention per se or in any combination, independent of their inclusion in the claims or their back-reference.

### BRIEF DESCRIPTION OF THE DRAWINGS

FIG. 1 shows a process diagram of a method and a plant in accordance with the present invention, and

FIG. 2 shows a reactor in accordance with the present invention.

### DETAILED DESCRIPTION OF THE PREFERRED EMBODIMENTS

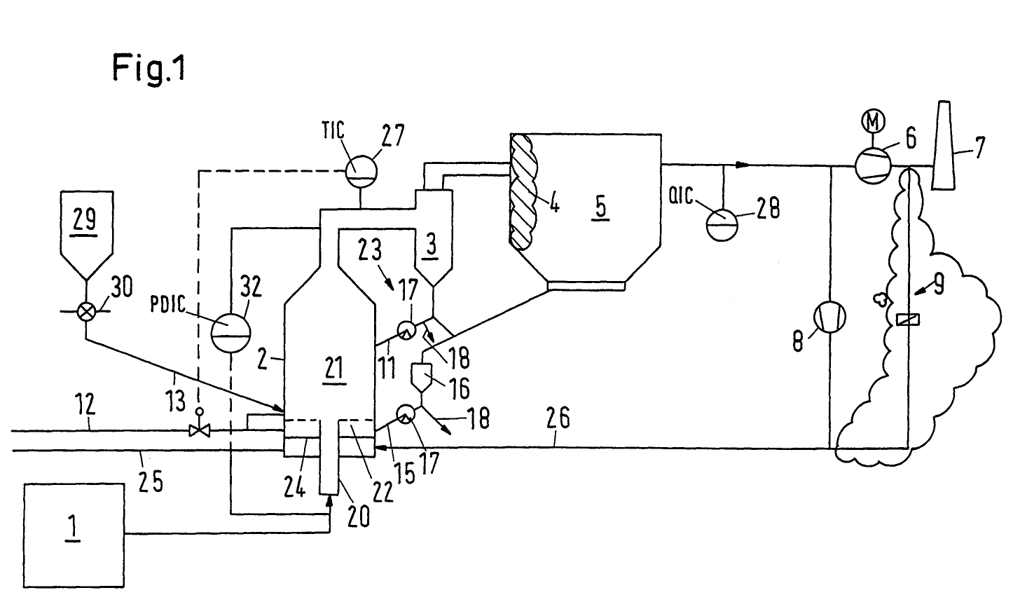

With reference to FIG. 1, the plant and the method for removing gaseous pollutants from exhaust gases will first be described in general to explain the operation in accordance with the invention.

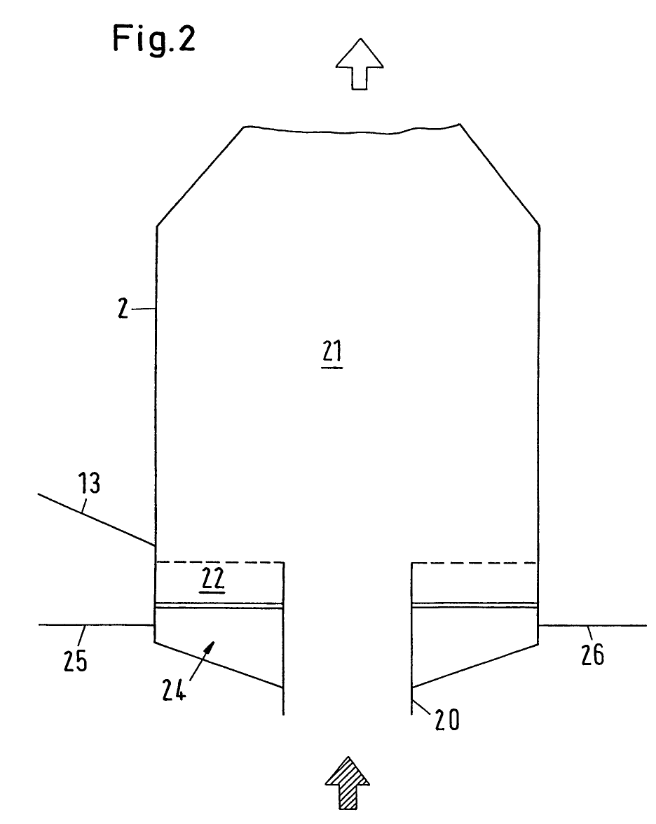

For the dry gas cleaning of exhaust gases with gaseous pollutants such as hydrogen fluoride HF, hydrogen chloride HCl or sulfur dioxide SO₂, the plant includes a for instance cylindrical reactor 2, which is represented in FIG. 2 on an enlarged scale, with a gas supply tube (central tube) 20 for supplying the exhaust gas to be cleaned, which is arranged approximately coaxially with the longitudinal axis of the reactor. The central tube 20 extends upwards substantially vertically from the bottom of the reactor 2. In the vicinity of the bottom of the reactor 2, an annular gas distributor 24 is provided, into which open supply conduits 25 and 26. In the vertically upper region of the reactor 2, which defines a mixing chamber 21, an outlet conduit is arranged, which opens into a separator 3 constituting a cyclone.

When fine-grained reactant is now introduced into the reactor 2 via a solids conduit 13 (reactant supply conduit), a layer annularly surrounding the central tube 20 is formed on the gas distributor 24, which layer is referred to as annular fluidized bed 22. Fluidizing gas introduced through the supply conduit 25, 26 flows through the gas distributor 24 and fluidizes the annular fluidized bed 22, so that a stationary fluidized bed is formed. Preferably, the gas distributor 24 constitutes a fabric for this purpose. The velocity of the fluidizing gas supplied to the reactor 2 is adjusted such that the Particle-Froude-Number in the annular fluidized bed 22 is between about 0.3 and 1.1.

Due to the supply of more reactant into the annular fluidized bed 22, the solids level in the reactor 2 rises to such an extent that reactant gets into the orifice of the central tube 20. Through the central tube 20, the exhaust gas to be cleaned, which is generated by an upstream process 1, for instance a combustion, is at the same time introduced into the reactor 2. The velocity of the exhaust gas supplied to the reactor 2 through the central tube 20 preferably is adjusted such that the Particle-Froude-Number in the central tube 20 is about 30 to 90 and in the mixing chamber 21 about 4 to 12.

Since the solids level of the annular fluidized bed 22 is raised above the upper edge of the central tube 20, reactant flows over this edge into the central tube 20. The upper edge of the central tube 20 can be straight or have some other shape, for instance be serrated, or have lateral apertures. Due to the high gas velocities, the exhaust gas flowing through the central tube 3 entrains reactant from the stationary annular fluidized bed 22 into the mixing chamber 21 when passing through the upper orifice region, whereby an intensively mixed suspension is formed. In the mixing chamber 21, the gaseous pollutants react with the granular reactant by forming solids.

As a result of the reduction of the flow velocity by the expansion of the gas jet in the mixing chamber 21 and/or by impingement on one of the reactor walls, the entrained reactant grains quickly lose speed and partly fall back into the annular fluidized bed 22 together with the solids formed. Between the reactor regions of the stationary annular fluidized bed 22 and the mixing chamber 21 a circulation is obtained. Because of this circulation, the reactant circulates in the reactor 2 for a particularly long time, and the very good mass and heat transfer conditions in the mixing chamber 21 can be utilized at the same time.

Due to the good reaction conditions in the mixing chamber 21, which are caused by the high turbulence and the associated good mass and heat transfer conditions, and because of the long retention time of the reactant in the annular fluidized bed 22, the reaction can be performed until very low clean gas concentrations are achieved with almost stoichiometric consumptions of the reactant.

The reactant and the solids formed in the reaction, which are not separated from the exhaust gas stream above the central tube 20 in the mixing chamber 21 and directly fall back into the annular fluidized bed 22, are discharged from the reactor 2 upwards through an outlet conduit together with the now cleaned exhaust gas stream, are partly separated from the exhaust gas stream in a coarse separator 3, 4, and are recirculated for the most part through the solids return conduit 11 into the annular fluidized bed 22. Depending on the reaction, solids and reactant are discharged from the recirculation circuit of the recirculation system 23 for a certain, preferably small part through the discharge conduit 18. The coarse separator includes a cyclone 3 and a shutter-type mechanical separator 4.

In the fine separator 5 constituting an electrostatic or bag filter, which is provided downstream of the coarse separator 3, 4, the remaining solids are removed from the exhaust gas stream before releasing the exhaust gas into the atmosphere via a chimney 7. The solids including the reactant, which were separated in the fine separator 5, are also recirculated in part or discharged from the circuit. For fine separation, all kinds of fine separators 5 can be used, in particular mechanical separators, filtrating separators or electrostatic filters.

The recirculation system 23 consists of corresponding solids return conduits 11, 15 with shut-off devices, one or more buffer vessels 16, and in particular dosing devices 17 arranged subsequent to the buffer vessel 16, for instance roller-type mechanical valves or feed rolls. The recirculation for the coarse and fine material can be effected separately or jointly.

The non-recirculated solids are discharged from the process via discharge conduits 18, in part only from the coarse or fine material of the recirculation stream. The amount of solids recirculated can be up to 10 times as large as the freshly added amount of reactant.

In some applications, however, the entire reactant passed through the exhaust gas cleaning plant and the reaction products (solids) can be processed. Thus, there is no true consumption of reactant. Therefore, such cleaning methods can be operated by adding fresh reactants with high stoichiometric values, so that a recirculation of separated reactant is not necessary to minimize consumption. The discharged or recirculated solids for the most part consist of completely reacted reactant or for a small part of not completely reacted reactant.

For controlling the recirculation amount, the differential pressure can be utilized via the mixing chamber 21 (PDIC). Said differential pressure is simply measured by a pressure gauge 32 arranged at a bypass conduit bridging the reactor and supplied to a corresponding controller. The set point adjustment for the differential pressure 14 via the mixing chamber 21 influences the pollutant concentration in the clean gas and/or the consumption of reactant, i.e. the higher the adjusted differential pressure 14, the lower the pollutant concentration in the clean gas or the consumption of reactant.

Fresh reactant is supplied to the annular fluidized bed 22 for instance from a silo 29 via the reactant supply conduit 13. For the respective object, suitable fine-grained materials will be used as reactant, such as alum earth Al₂O₃, sodium carbonate Na₂CO₃, hydrated lime Ca(OH)₂, burnt lime CaO, etc. The supply of reactant is effected in dependence on the pollutant concentration in the clean gas (cleaned exhaust gas) and is automatically adjusted by a corresponding controller (QIC), which is connected with the pollutant concentration measuring device 28, via a dosing device 30. With increasing pollutant concentration in the clean gas, the dosing rate for the reactant is increased.

As an additional degree of freedom for influencing the pollutant concentration in the clean gas or for minimizing the consumption of reactant, the variation of the gas recirculation into the annular fluidized bed is optionally available. When the pollutant concentration in the clean gas is rising, the gas recirculation rate of the cleaned centration in the clean gas is rising, the gas recirculation rate of the cleaned exhaust gas through the gas return conduit 26 is increased. As a result, the gas input and the velocity in the annular fluidized bed 22 are increased. The annular fluidized bed 22 is raised and the solids overflow into the central tube 20 (central tuyere) or into the mixing chamber 21 is raised. Thus, the gas-solids reaction taking place in the mixing chamber 21 can be shifted towards lower clean gas values. This control variable can very easily be used for compensating noxious gas peaks in the exhaust gas (raw gas). The amount of gas recirculated from the clean gas side to the annular fluidized bed 22 is between 5 and 10% of the amount of exhaust gas supplied to the system. The gas recirculation to the annular fluidized bed can be effected by means of a separate blower 8 or via the pressure side of the system and the main blower 6 through a return conduit 9 with control valve.

The optimum temperature for the desired chemical reaction in the reactor 2 depends on the reactant and the gaseous pollutant to be removed. The optimum reaction temperature, which is measured by a temperature gauge 27 in the exhaust gas stream behind the reactor 10, is adjusted by means of water injection 12 and adiabatic evaporation (TIC). The water is injected onto the surface of the stationary annular fluidized bed 22 (fluidized bed) or directly into the stationary annular fluidized bed 22. The annular fluidized bed 22 represents a defined space in which there occurs a fast evaporation even of larger water droplets with a diameter up to 1 mm due to the good mass transfer conditions. This provides for dosing the water to be evaporated also with lower pressures. Dosing the water injected into the annular fluidized bed 22 can be effected via simple tubes or one or more nozzles.

This kind of water injection is a considerable advantage as compared to the two-fluid nozzle systems or high-pressure nozzle systems required in the previous Venturi-type fluidized-bed reactors. The reason for the use of high-pressure nozzles is the undefined position and the undefined condition of the Venturi-type fluidized bed. To therefore reduce the evaporation time of the droplets, very small droplet diameters must be produced. This requires a high-pressure nozzle system, which can be omitted in the reactor 2 in accordance with the invention.

When the volume flow of the exhaust gas supplied is decreasing very much in partial-load operation, it is also possible to supply clean gas from the pressure side of the induced-draught ventilator 6, 8 to the exhaust gas to be cleaned before the central tube 20 of the annular-fluidized-bed reactor 2. In this way, a stable operation of the annular-fluidized-bed reactor is ensured.

Because of the good reaction conditions in the mixing chamber 21 due to the high turbulences and the associated good mass and heat transfer conditions and due to the long retention time of the reactant in the fluidized bed, the reaction for the dry exhaust gas cleaning can be performed in accordance with the invention until very low clean gas concentrations are achieved with almost stoichiometric consumptions of the reactant. In this way, a particularly effective exhaust gas cleaning is achieved with a low consumption of reactant. Apart from the above-mentioned applications, the gas cleaning method in accordance with the invention can also be used for cleaning SO₂-containing exhaust gases from sintering plants.

### EXAMPLE 1

### Removal of Hydrogen Fluoride from the Exhaust Gas Stream of Electrolytic Cells for Producing Aluminum

In the smelting flux electrolysis of aluminum, considerable amounts of gaseous hydrogen fluoride (HF) are released. This pollutant gets into the furnace exhaust gas and must be removed from the exhaust gas before the gas is released into the atmosphere.

The combined exhaust gas stream from the electrolytic cells 1 enters the central tube 20 surrounded by the annular fluidized bed 22 with a temperature of 50 to 150° C. Recirculated clean gas or—if available—particle-free exhaust gas from a gas stream conducted in parallel is supplied to the annular chamber of the reactor 2 with the annular fluidized bed 22. By adjusting the optimum temperature in the annular fluidized bed 22 through water injection 12 or evaporation of water, the optimum effect can be achieved for the reaction. The water injection 12 is effected directly into the annular fluidized bed 22.

The Particle-Froude-Numbers Fr_{P} in the central tube 20 are about 36, in the annular fluidized bed 22 about 0.36, and in the mixing chamber 21 about 5.1.

As reactant, common alumina (alum earth, Al₂O₃) is used. Due to the large specific surface, alumina absorbs the hydrogen fluoride and in part forms aluminum fluoride AlF₃. The entire material which is passed through the fluorine removal plant gets into the electrolytic cells, where it can be processed to obtain aluminum. Thus, a consumption does not occur. Therefore, the annular-fluidized-bed reactor plants for exhaust gas cleaning can be operated without recirculation of solids.

As in this application relatively low temperatures occur, the tuyere bottom of the gas distributor 24 can constitute a non-temperature-resistant fabric.

Typical reaction data can be taken from the following Table. The standard cubic meters (Nm³) indicate the volume flow based on the standard conditions (273° K, 1013 mbar).

| | | |
|---|---|---|
| Gas quantity: | 100,000-2,000,000 | m³/h |
| Gas temperature: | 50-150 | ° C. |
| HF content in the exhaust gas | 5-1000 | mg/Nm³ |
| HF content in the clean gas: | <1-5 | mg/Nm³ |

A design example for a fluorine removal plant with about sixty electrolytic cells of an aluminum-making plant is given below:

| Design variable | | Number/Remark | | Unit | |
|---|---|---|---|---|---|
| Volume flow | | 300000 | | Nm³(dry)/h | |
| Gas composition (dry): | | | | | |
| Oxygen, O₂ | | 18 | | Vol-% (dry) | |
| Carbon dioxide, CO₂ | | 3 | | Vol-% (dry) | |
| Nitrogen (N₂), | | Rest | | Vol-% (dry) | |
| inert gases | | | | | |
| Dew point of water | Steam | 21 | 22 | ° C. | g/Nm³ |
| | content | | | | (dry) |

| | | |
|---|---|---|
| Noxious gases: | exhaust | clean |
| | gas | gas |

| | | | |
|---|---|---|---|
| Hydrogen fluoride, HF | 40-90 | <1 | mg/Nm³ |
| Hydrogen chloride, HCl | — | — | mg/Nm³ |
| Sulfur dioxide, SO2 | 150-200 | <200 | mg/Nm³ |
| Dust content | 500 | <20 | mg/Nm³ |

| | | |
|---|---|---|
| Temperature | 100 | ° C. |

The following consumption is obtained:

Consumption figures:

| | | | |
|---|---|---|---|
| Reactant | 300 | kg/h | No solids recirculation |
| (Alumina, alum earth) | | | |

### EXAMPLE 2

### Removal of Acid Gases from the Flue Gas Stream of Combustion Plants

In combustion processes, the sulfur, fluorine and chlorine compounds bound in the fuel are converted by means of various equilibrium reactions to substantially obtain sulfur dioxide SO₂, hydrogen fluoride HF and hydrogen chloride HCl. This happens for instance in power plants and incineration plants for waste or special waste. These gaseous compounds are discharged with the exhaust gas from the combustion space 1 and must be removed from the exhaust gas stream before being released into the atmosphere.

For removing acid components from exhaust gases (flue gases), a large number of various wet, dry and quasi-dry methods has already been developed. All methods have in common that the removal of the acid components is effected simultaneously by means of alkaline reagents.

The exhaust gas stream from a combustion plant 1 is supplied to the central tube 20 (central tuyere). The temperature at the inlet of the central tube 20 is about 100 to 250° C.

Recirculated clean gas or—if available—particle-free exhaust gas from a gas stream conducted in parallel—is supplied to the annular fluidized bed 22 formed in the annular chamber. The activity of the annular fluidized bed 22 can be increased by means of water injection 12 and the resulting increase of the water content in the exhaust gas and by adiabatic evaporation while decreasing the gas temperature at the same time. The water injection 12 is effected through one or more nozzles directly onto the surface of the annular fluidized bed 22 or into the same.

The Particle-Froude-Numbers Fr_{P} in the central tube 20 are about 89, in the annular fluidized bed 22 about 1.0, and in the mixing chamber 21 about 10.

Calcium compounds such as hydrated lime Ca(OH)₂ or burnt lime CaO (caustic lime) are used as reagents. Sulfur dioxide reacts with the calcium compounds by forming sulfites or sulfates. To minimize the consumption of reagent, part of the solids separated in the pre- or fine separator 4, 5 are recirculated. The recirculation phase can be up to ten times as large as the feed rate for fresh reagent. Due to the good mass transfer conditions in the annular fluidized bed 22 and the mixing chamber 21, a high degree of separation is achieved.

Typical reaction data can be taken from the following Table.

| | | |
|---|---|---|
| Gas quantity: | 5000-500000 | m³/h |
| Gas temperature: | 100-250 | ° C., |
| | | after prededusting |
| S0₂ content in the exhaust gas: | 10-20000 | mg/Nm³ |
| HCl content in the exhaust gas: | 5-5000 | mg/Nm³ |
| HF content in the exhaust gas: | 5-1000 | mg/Nm³ |
| SO₂ content in the clean gas: | <10-50 | mg/Nm³ |
| HCl content in the clean gas: | <1-50 | mg/Nm³ |
| HF content in the clean gas: | <1-50 | mg/Nm³ |

A design example for a line of a waste incineration plant for about 400 daily tons domestic waste is given below:

| Design variable | | Number/Remark | | Unit | |
|---|---|---|---|---|---|
| Volume flow | | 60000 | | Nm³(dry)/h | |
| Gas composition (dry): | | | | | |
| Oxygen, O₂ | | 8.5 | | Vol-% (dry) | |
| Carbon dioxide, CO₂ | | 11.5 | | Vol-% (dry) | |
| Nitrogen (N₂), | | Rest | | Vol-% (dry) | |
| inert gases | | | | | |
| Dew point of water | Steam | 55 | 150 | ° C. | g/Nm³ |
| | content | | | | (dry) |

| | | |
|---|---|---|
| Noxious gases: | exhaust | clean |
| | gas | gas |

| Hydrogen fluoride, HF | <30 | <1 | mg/Nm³ |
|---|---|---|---|
| Hydrogen chloride, HCl | <1200 | <10 | mg/Nm³ |
| Sulfur dioxide, SO₂ | <500 | <50 | mg/Nm³ |
| Temperature | 180-220 | | ° C., behind |
| | | | boiler |
| Dust content | 5000 | <10 | mg/Nm³ |

| | | |
|---|---|---|
| Temperature | 180-210 | ° C. |

The following consumption is obtained:

Consumption figures:

| | | | |
|---|---|---|---|
| Reactant lime Ca(OH)₂ | 130 | kg/h | Solids recirculation |
| | | | with about 300% |
| Water | 1500-3000 | kg/h | |
| Recirculated amount | about 400 | kg/h | |

### EXAMPLE 3

### Removal of Sulfur Dioxide, Hydrogen Fluoride and Hydrogen Chloride from the Exhaust Gas Stream of a Thermal Production Process

In some production processes, for instance glass production, cement production, in calcining plants and in metallurgical processes, clean noxious gases are released during the production process. For gas cleaning basically similar methods are used as for the above-described combustion plants. In many fields of industry, however, a lower efficiency or a higher emission is permitted.

In this example, the exhaust gas stream from the production process is supplied to the central tube 20 of the reactor 2. The temperature at the inlet of the central tube is about 200 to 600° C. Recirculated clean gas or—if available—particle-free exhaust gas from a gas stream conducted in parallel is supplied to the annular fluidized bed 22.

The Particle-Froude-Numbers Fr_{P} in the central tube 20 are about 77, in the annular fluidized bed 22 about 0.77, and in the mixing chamber 21 about 10.7.

Calcium compounds such as lime Ca(OH)₂, limestone CaCO₃ or burnt lime CaO are used as reagents. Sulfur dioxide reacts with the calcium compound by forming sulfites or sulfates. Due to the good mass transfer conditions in the annular fluidized bed, a high degree of separation is achieved. In some applications, the reactant used for separating pollutants and the reaction products can be processed in the process. Thus, there is no true consumption. Thus, the reactant throughput through the exhaust gas cleaning plant is of subordinate importance. In these cases, the recirculation is omitted and the freshly added amount of reactant is correspondingly increased, in order to ensure the required clean gas contents.

Typical reaction data can be taken from the following Table.

| | | |
|---|---|---|
| Gas quantity: | 5000-500000 | m³/h |
| Gas temperature: | 200-600 | ° C. |
| SO₂ content in the exhaust gas: | 1000-20000 | mg/Nm³ |
| HCl content in the exhaust gas: | 50-5000 | mg/Nm³ |
| HF content in the exhaust gas: | 20-1000 | mg/Nm³ |
| SO₂ content in the clean gas: | <500-2000 | mg/Nm³ |
| HCl content in the clean gas: | <10-50 | mg/Nm³ |
| HF content in the clean gas: | <3-50 | mg/Nm³ |

A design example for exhaust gas from a melting trough for about 600 daily tons flat glass is given below:

| Design variable | | Number/Remark | | Unit | |
|---|---|---|---|---|---|
| Volume flow | | 83000 | | Nm³(dry)/h | |
| Gas composition (dry): | | | | | |
| Oxygen, O₂ | | 8 | | Vol-% (dry) | |
| Carbon dioxide, CO₂ | | 12 | | Vol-% (dry) | |
| Nitrogen (N₂), | | Rest | | Vol-% (dry) | |
| inert gases | | | | | |
| Dew point of water | Steam | 45 | 90 | ° C. | g/Nm³ |
| | content | | | | (dry) |

| | | |
|---|---|---|
| Noxious gases: | exhaust | clean |
| | gas | gas |

| | | | |
|---|---|---|---|
| Hydrogen fluoride, HF | 20 | <5 | mg/Nm³ |
| Hydrogen chloride, HCl | 90 | <30 | mg/Nm³ |
| Sulfur dioxide, SO₂ | 1000 | <500 | mg/Nm³ |
| Dust content | 200 | <20 | mg/Nm³ |

| | | |
|---|---|---|
| Temperature | 360-380, max 450 | ° C. |

The following consumption is obtained:

Consumption figures:

| | | | |
|---|---|---|---|
| Lime Ca(OH)₂ | 80 | kg/h | with 0% recirculation |
| Water | 0-2000 | kg/h | |
| Recirculated material | 40 | kg/h | with 50% recirculaton |

### LIST OF REFERENCE NUMERALS

1 process
2 reactor
3 cyclone, coarse separator
4 shutter-type separator, coarse separator
5 electrostatic or bag filter, fine separator
6 main blower
7 chimney
8 blower
9 return conduit with control valve
11 solids return conduit
12 water injection
13 reactant supply conduit
15 solids return conduit
16 buffer vessel
17 dosing device
18 discharge conduits
20 central tube
21 mixing chamber
22 stationary annular fluidized bed
23 recirculation system
24 gas distributor
25 supply conduit
26 gas return conduit
27 temperature gauge
28 pollutant concentration measuring device
29 silo
30 dosing device
32 pressure gauge

1. A method for removing gaseous pollutants from exhaust gases, in which the gaseous pollutants react with a fine-grained reactant by forming solids in a fluidized-bed reactor, wherein the exhaust gas is introduced from below through a preferably central gas supply tube into a mixing chamber of the reactor, the gas supply tube being at least partly surrounded by a stationary annular fluidized bed of reactant, which bed is fluidized by supplying fluidizing gas, and that the gas velocities of the exhaust gas and of the fluidizing gas for the annular fluidized bed are adjusted such that the Particle-Froude-Numbers in the gas supply tube are between 1 and 100, in the annular fluidized bed between 0.02 and 2, and in the mixing chamber between 0.3 and 30.

2. The method as claimed in claim 1, wherein the Particle-Froude-Number in the gas supply tube is between 20 and 90.

3. The method as claimed in claim 1, wherein the Particle-Froude-Number in the annular fluidized bed is between 0.2 and 1.2.

4. The method as claimed in claim 1, wherein the Particle-Froude-Number in the mixing chamber is between 3 and 15.

5. The method as claimed in claim 1, wherein the bed height of the reactant in the reactor is adjusted such that the annular fluidized bed extends beyond the upper orifice end of the gas supply tube, and that reactant is constantly introduced into the exhaust gas and entrained by the gas stream to the mixing chamber located above the orifice region of the gas supply tube.

6. The method as claimed in claim 1, wherein the exhaust gas contains sulfur dioxide, hydrogen fluoride and/or hydrogen chloride and that alumina, sodium carbonate and/or calcium compounds, in particular hydrated or burnt lime, with a grain size of less than 100 μm is supplied as reactant.

7. The method as claimed in claim 1, wherein the exhaust gas is prededusted before being supplied to the reactor 4.

8. The method as claimed in claim 1, wherein the solids formed and possibly reactant are discharged from the reactor with the exhaust gas stream, supplied to at least one separator, and recirculated into the annular fluidized bed and/or the mixing chamber of the reactor and/or discharged.

9. The method as claimed in claim 8, wherein the recirculated amount of solids is up to 10 times the freshly added amount of reactant.

10. The method as claimed in claim 8, wherein the control of the recirculation amount is effected in dependence on the differential pressure above the mixing chamber.

11. The method as claimed in claim 8, wherein the supply of reactant is effected in dependence on the concentration of the pollutants in the cleaned exhaust gas.

12. The method as claimed in claim 8, wherein cleaned exhaust gas and/or air is introduced into the annular fluidized bed of the reactor as fluidizing gas.

13. The method as claimed in claim 12, wherein the rate of the recirculated cleaned exhaust gas depends on the pollutant concentration in the cleaned exhaust gas and is in particular between 5 and 10% of the amount of exhaust gas supplied to the reactor.

14. The method as claimed in claim 12, wherein in dependence on the temperature in the reactor and/or the temperature of the cleaned exhaust gas leaving the reactor water is injected into the reactor.

15. The method as claimed in claim 12, wherein to the exhaust gas in the gas supply tube cleaned exhaust gas is admixed as clean gas in particular in dependence on the exhaust gas volume flow.

16. A plant for removing gaseous pollutants from exhaust gases, in particular for performing a method as claimed in claim 1, comprising a reactor constituting a fluidized-bed reactor, wherein the reactor has a gas supply system which is formed such that exhaust gas flowing through the gas supply system entrains reactant from a stationary annular fluidized bed, which at least partly surrounds the gas supply system, into the mixing chamber.

17. The plant as claimed in claim 16, wherein the gas supply system has a gas supply tube which extends upwards substantially vertically from the lower region of the reactor into the mixing chamber of the reactor, the gas supply tube being surrounded by a chamber which at least partly annularly extends around the gas supply tube and in which the stationary annular fluidized bed is formed.

18. The plant as claimed in claim 16, wherein the gas supply tube is arranged approximately centrally with reference to the cross-sectional area of the reactor.

19. The plant as claimed in claim 16, wherein at least one separator for separating solids in the cleaned exhaust gas is provided downstream of the reactor and that a recirculation system with a solids conduit leading to the annular fluidized bed of the reactor, a solids conduit leading into the mixing chamber of the reactor, and/or a solids discharge conduit is provided downstream of the separator.

20. The plant as claimed in claim 19, wherein the recirculation system includes a buffer vessel and a dosing means.

21. The plant as claimed in claim 16, wherein in the annular chamber of the reactor a gas distributor is provided, which divides the annular chamber into an upper annular fluidized bed and a lower gas distributor chamber, the gas distributor chamber being connected with a supply conduit for fluidizing gas, in particular air and/or cleaned exhaust gas.

22. The plant as claimed in claim 16, wherein behind the separator on the exhaust gas side a clean gas supply conduit is provided for clean gas recirculation into the annular fluidized bed of the reactor and/or into the gas supply tube.

23. The plant as claimed in claim 16, wherein a water supply conduit is provided for water injection into and/or onto the annular fluidized bed of the reactor.

24. The plant as claimed in claim 16, wherein a differential pressure gauge, a temperature gauge and/or a gas meter.

25. The plant as claimed in claim 24, wherein to the differential pressure gauge, the temperature gauge and/or the gas meter a controller is connected for adjusting pressure, temperature and/or concentration of the pollutants in the clean gas.
